(19) United States
(12) Patent Application Publication
(10) Pub. No.: US 2008/0278274 A1
(43) Pub. Date: Nov. 13, 2008

(54) Combined transformer

(75) Inventors: Ying-Chian Kang, Taoyuan Hsien (TW); Neng-Kuei Huang, Taoyuan Hsien (TW); Ching-Man Kao, Taoyuan Hsien (TW); Han-Cheng Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/068,209

(22) Filed: Feb. 4, 2008

(30) Foreign Application Priority Data
May 11, 2007 (TW) 96116774

(51) Int. Cl. H01F 27/30

(52) U.S. Cl. 336/198

(57) ABSTRACT

A transformer includes a first bobbin, a second bobbin, and an iron core set, wherein the first bobbin and the second bobbin further include a winding region and a through hole in the center of the bobbin, respectively. The winding region is wound by a winding. The iron core set is coupled to the first and second bobbins. The first and second bobbins are assembled together by a base.

### BACKGROUND OF THE INVENTION

1. Field of the Invention

The invention relates to a vertical transformer, and more particularly to a vertical transformer structure for combining two transformers.

2. Description of the Related Art

Transformers are an electronic elements usually applied to all types of electronic devices. Referring to FIG. 1, a conventional transformer 1 includes a bobbin 11, a winding assembly 12, a base 13 and two iron cores 14. The winding assembly, 12 includes an enameled wire to wind a winding region 111 of the bobbin 11. The base 13 is connected to the bobbin 11 and includes a plurality of pins 131 electrically connected to a printed circuit board 15. The iron cores 14 are correspondingly disposed, on two sides of the bobbin 11 and coupled each other so that the electromagnetic induction can be generated by the iron cores 14 and the winding assembly 12. The axle of the bobbin 11 is parallel to the pins 131 of the base 13. Thus, the transformer is a vertical transformer. If the axle of the bobbin 11 is perpendicular to the pins of the base, the transformer will be a lateral transformer (not shown). The transformer is related to electric transformation and thus, the transformer is conformed to a safe standard. The distances between the iron cores 14 and the printed circuit board 15 and between the iron cores 14 and the winding assembly 11 are limited according to the safe standard. Normally, electronic devices comprise a plurality of transformers therein, thus, the sizes of the electronic devices using the plurality of transformers are not easily shrunk. It is desired to provide a combined transformer conforming to the safe standard and allowing for shrinkage of electronic elements and devices.

### BRIEF SUMMARY OF INVENTION

A detailed description is given in the following embodiments with reference to the accompanying drawings. The invention provides a vertical transformer by combining two transformers.

A combined transformer applied to an electronic device includes a first bobbin, a first base, a second bobbin, a second base, and an iron core set. The first bobbin includes a winding region and a through hole in the center thereof. The winding region is wound by a winding. The first base connected to the first bobbin includes a first opening communicated with the through hole of the first bobbin. The second bobbin includes a winding region and a through hole in the center thereof. The winding region is wound by a winding. The second base connected to the second bobbin includes a second opening communicated with the through hole of the second bobbin. The iron core set includes a first iron core and a second iron core. The first and second iron cores include a central protrusion and a side protrusion, respectively. The central protrusion is connected to the side protrusion via a horizontal part. The side protrusion of the first iron core is connected to the through hole of the first bobbin and the first opening. The side protrusion of the second iron core is connected to the through hole of the second bobbin and the second opening. The central protrusion is disposed between the first and second bobbins. The first and second bobbins are disposed on two sides of the iron core set, respectively.

### BRIEF DESCRIPTION OF DRAWINGS

The present invention will be more fully understood from the subsequent detailed description and the accompanying drawings, which are given by way of illustration only, and thus are not limitative of the present invention, and wherein:

FIG. 1 is a schematic view of a conventional transformer;

FIG. 2 is an exploded view of two bobbins of the invention;

FIG. 3 is a schematic view of an embodiment of a bobbin of the invention;

FIG. 4 is an exploded view of a combined transformer of the invention; and

FIG. 5 is a schematic view of a combined transformer of the invention.

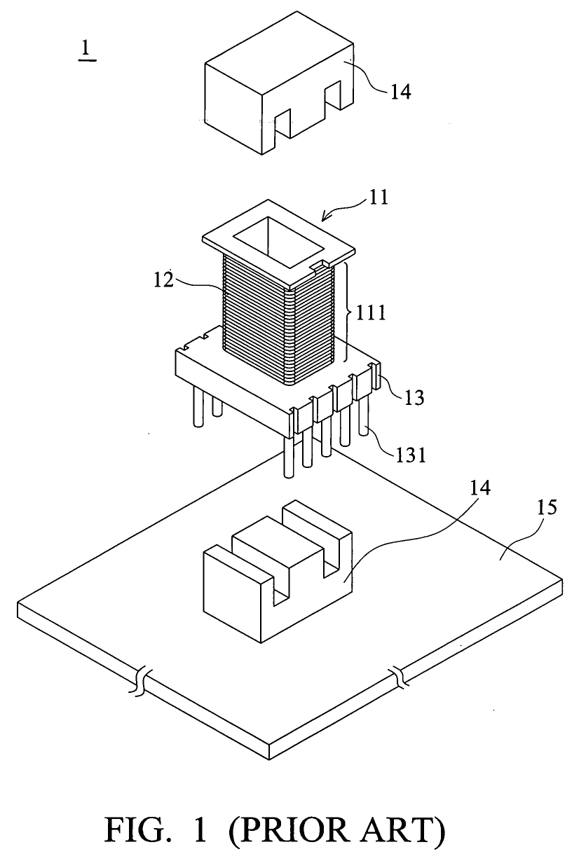

### DETAILED DESCRIPTION OF INVENTION

The following description is of the best-contemplated mode of carrying out the invention, this description is made for the purpose of illustrating the general principles of the invention and should not be taken in a limiting sense. The scope of the invention is best determined by reference to the appended claims.

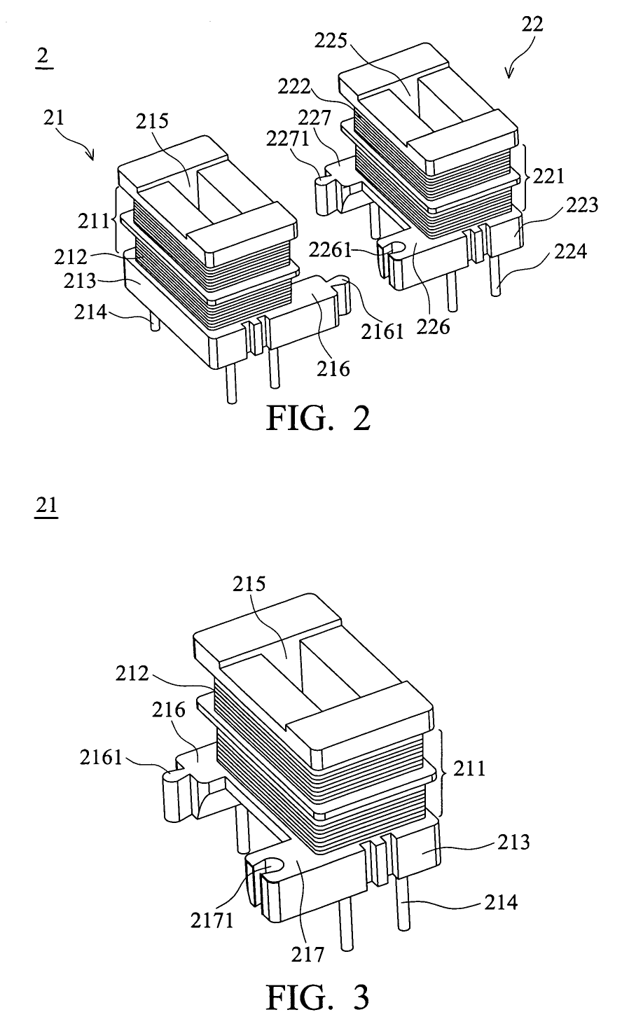

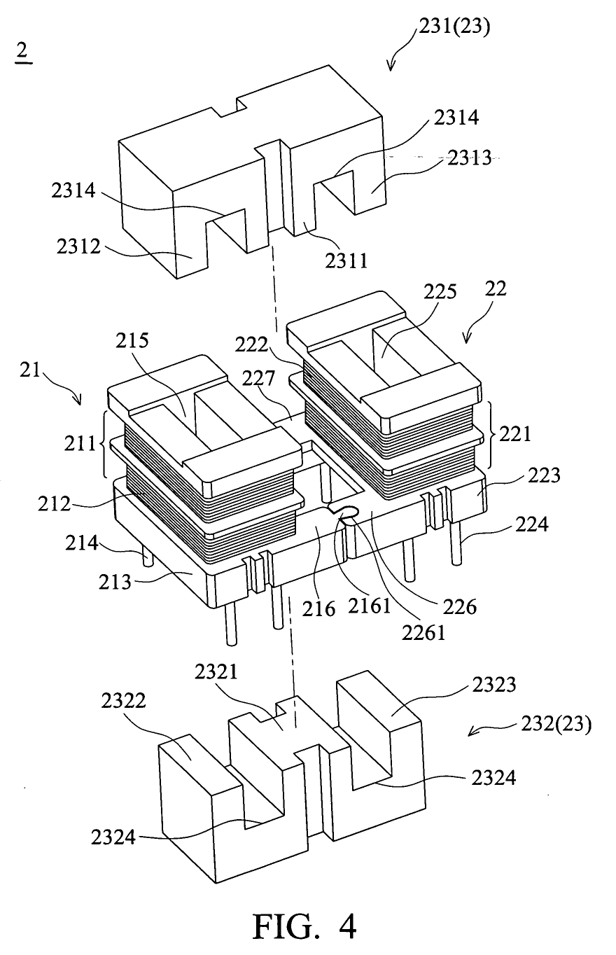

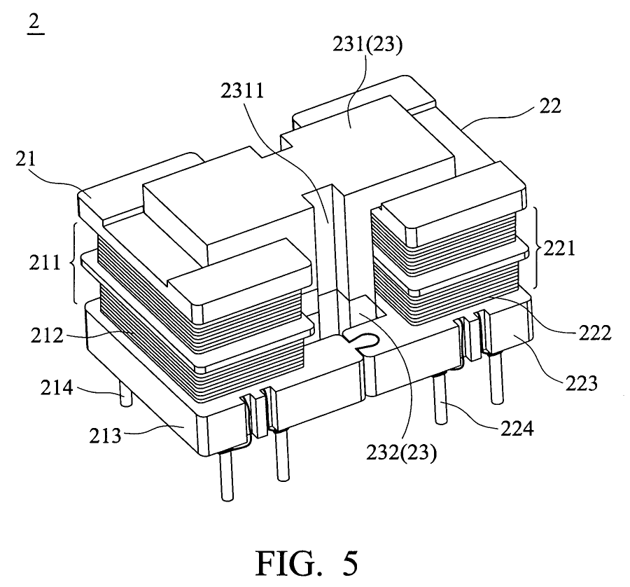

Referring to FIGS. 2, 3, 4 and 5 a combined transformer 2 of an embodiment includes a first bobbin 21, a first base 213, a second bobbin 22, a second base 223, and an iron core set 23. The combined transformer 2 is applied to an electronic device. In this embodiment, the transformer 2 is a vertical transformer or a high-frequency transformer.

The first and second bobbins 21, 22 include winding regions 211 and 221, respectively. At least an enameled wire is wound on the winding regions 211 (221) to form a winding 212(222). The windings 212 and 222 act as a primary winding and a secondary winding of the transformer 2. The first and second bobbins 21, 22 both include a first base 213 and a second base 223 disposed under the winding regions 211 and 221, respectively. The bases 213 arid 223 include a plurality of pins 214 and 224, respectively. The bases 213 and 223 are electrically connected to a printed circuit board of an outside electronic device (not shown) via the pins 214 and 224, respectively. Two through holes 215 and 225 are disposed in the center of the bobbins 21 and 22, respectively. The bases 213 and 223 include openings (not shown) communicated with the through holes 215 and 225, respectively. In this embodiment of the invention, the first and second bases 213, 223 and the first and second bobbins 21, 22 are formed as a single unitary member or assembled together by engaging or adhesion, respectively.

In this embodiment of the invention, one side of the first base 213 includes a first extending portion 216 and a second extending portion 217. A suitable interval between the first extending portion 216 and the second extending portion 217 exists. The front end of the first extending portion 216 includes a protrusion 2161 and the front end of the second extending portion 217 includes a depression 2171. One side of the second base 223 includes a third extending portion 226 and a fourth extending portion 227 corresponding to the first extending portion 216 and the second extending portion 217, respectively. The front end of the third extending portion 226 includes a protrusion 2261 and the front end of the fourth extending portion 227 includes a depression 2271. The protrusion 2161 of the first extending portion 216 is engaged with the depression 2261 of the third extending portion 226. The protrusion 2271 of the fourth extending portion 227 is engaged with the depression 2161 of the first extending portion 216. Thus, the first base 213 is combined with the second base 223.

Another embodiment of the invention discloses another connection method for the first base 213 and the second base 223. The front ends of the first extending portion 216 and the second extending portion 217 respectively include a protrusion 2161. The front ends of the third extending portion 226 and the fourth extending portion 227 respectively include a depression 2261. At least a protrusion 2161 of the base 213 is engaged with the depression 2261 of another base or the amount depression 2261 corresponding to the protrusion 2161 (not shown). Thus, the first base 213 is combined with the second base 223. Of course, the connection of the first and second bases 213, 223 is not limited to the above disclosed embodiment. The first base 213 may be connected to the second base 223 via glue (not shown). Furthermore, the first and second bases 213, 223 can be formed as a single unitary member or assembled together by engaging or adhesion.

The iron core set 23 includes a first iron core 231 and a second iron core 232 disposed on two corresponding ends of bobbins 21 and 22. The windings 212 and 222 generate electromagnetic induction coupling to transform voltage. In this embodiment, the iron core set 23 may be an EE iron core set, an EI iron core set, an RM iron core set, an E iron core set, a PQ iron core set, an EC iron core set, or an ETD iron core set.

The first iron core 231 includes a central protrusion 2311 and two side protrusions 2312 and 2313. The central protusions 2311 is connected to the side protrusions 2312 and 2313 via a horizontal part 2314. The second iron core 232 includes a central protrusion 2321 and two side protrusions 2322 and 2323, and the central protrusion 2321 is connected to the side protrusions 2322 and 2323 via a horizontal part 2324. In this embodiment, the side protrusions 2312 and 2313 of the first iron core 231 and the side protrusions 2322 and 2323 of the second iron core 232 are connected to the through hole 215, the through hole 225, the first opening on the center of the first bobbin 213 (not shown) and the second opening on the center of the second bobbin 223 (not shown), respectively. The central protrusions 2311 and 2321 are disposed between the first and second bobbins 21, 22. Thus, the first and second bobbins 11, 22 are disposed on two sides of the iron core set 23, respectively.

The combined transformer 2 allows the iron core set 23 to be a connecting element for combining two bobbins 21 and 22. Space occupied by one iron core set 23 is saved to decreasing the volume of the transformer. Thus, space of an electronic device using the transformer is saved. The volume of the electronic device decreases. Thus, the combined transformer 2 of the invention allows an electronic element to be further shrunk.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended, claims should be accorded the broadest interpretation so as to encompass all such modifications and similar arrangements.

What is claimed is:

1. A transformer comprising:
a first bobbin having a winding region wound by a first winding;
a first base connected to the first bobbin;
a second bobbin having a winding region wound by a second winding;
a second base connected to the second bobbin and assembled with the first base; and
an iron core set coupled to the first bobbin and the second bobbin.

2. The transformer as claimed in claim 1, wherein the first bobbin and the second bobbin comprise a through hole, respectively, and
wherein the first base comprises a first opening communicated with the through hole of the first, bobbin, and the second base comprises a second opening communicated with to the through hole of the second bobbin.

3. The transformer as claimed in claim 2, wherein the iron core set comprises a first iron core and a second iron core, and the first and second iron cores comprise a central protrusion and a side protrusion, respectively, wherein the central protrusion is connected to the side protrusion via a horizontal part.

4. The transformer as claimed in claim 3, wherein the side protrusion of the first iron core is connected to the through hole of the first bobbin and the first opening, the side protrusion of the second iron core is connected to the through hole of the second bobbin and the second opening, the central protrusion is disposed between the first bobbin and the second bobbin, and the first bobbin and the second bobbin are disposed on two sides of the iron core set, respectively.

5. The transformer as claimed in claim 1, wherein the first and second windings comprise a primary winding and a secondary winding, respectively.

6. The transformer as claimed in claim 1, wherein the first base and the first bobbin are formed as a single unitary member, or the second base and the second bobbin are formed as a single unitary member.

7. The transformer as claimed in claim 1, wherein the first base or the second base comprises a plurality of pins.

8. The transformer as claimed in claim 1, wherein the first base and the second base are formed as a single unitary member, or assembled together by engaging or adhesion.

9. The transformer as claimed in claim 1, wherein the first base comprises a first extending portion and the second base comprises a second extending portion corresponding to the first extending portion.

10. The transformer as claimed in claim 9, wherein the first extending portion comprises a first connecting portion and the second extending portion comprises a second connecting portion so that the first base is connected to the second base by the connection of the first and second connecting portions.

11. The transformer as claimed in claim 10, wherein the first connecting portion and the second connecting portion are a protrusion and a depression, respectively.

12. The transformer as claimed in claim 1, wherein the first base comprises a first extending portion and a second extending portion, and the second base comprises a third extending portion and a fourth extending portion corresponding to the first extending portion and the second extending portion, respectively.

13. The transformer as claimed in claim 12, wherein the first extending portion comprises a first connecting portion, the second extending portion comprises a second connecting portion, the third extending portion comprises a third connecting portion corresponding to the first connecting portion, and the four extending portion comprise a fourth connecting portion corresponding to the second connecting portion for connecting the first base and the second base.

14. The transformer as claimed in claim 13, wherein the first connecting portion, the second connecting portion, the third connecting portion, and the fourth connecting portion are protrusions and depressions, respectively.

15. The transformer as claimed in claim 1, wherein the iron core set comprises an EE iron core set, an EI iron core set, an RM iron core set, an E iron core set, a PQ iron core set, an EC iron core set, or an ETD iron core set.

16. The transformer as claimed in claim 1, wherein the transformer is a vertical transformer or a high-frequency transformer.

17. A transformer comprising:
a first bobbin having a winding region;
a second bobbin having a winding region;
a base for assembling with the first bobbin and the second bobbin; and an iron core set coupled to the first bobbin, second bobbin and the base.

18. The transformer as claimed in claim 17, wherein the first bobbin and the second bobbin comprise a through hole, respectively, and
wherein the first base comprises a first opening communicated with the through hole of the first bobbin, and the second base comprises a second opening communicated with to the through hole of the second bobbin.

19. The transformer as claimed in claim 17, wherein the first and second windings comprise a primary winding and a secondary winding, respectively.

20. The transformer as claimed in claim 17, wherein the first base and the first bobbin are formed as a single unitary member, or the second base and the second bobbin are formed as a single unitary member.
